(19) United States
(12) Patent Application Publication
(10) Pub. No.: US 2020/0107422 A1
(43) Pub. Date: Apr. 2, 2020

(54) PROGRAMMABLE LIGHT-EMITTING DIODE (LED) LIGHTING SYSTEM AND METHODS OF OPERATION

(71) Applicant: Lumileds LLC, San Jose, CA (US)

(72) Inventor: Alan Andrew McREYNOLDS, Los Altos, CA (US)

(73) Assignee: Lumileds LLC, San Jose, CA (US)

(21) Appl. No.: 16/586,366

(22) Filed: Sep. 27, 2019

Related U.S. Application Data
(60) Provisional application No. 62/737,397, filed on Sep. 27, 2018.

(51) Int. Cl. H05B 45/12; F21V 23/00

(52) U.S. Cl. CPC H05B 45/12; F21Y 2115/10; F21V 23/003

(57) ABSTRACT

Programmable light emitting diode (LED) lighting systems and a method of operating the system are described. An LED may emit a beam of light at a particular location. The LED may sense, an illumination parameter from an external light source on the particular location. The LED may output a current proportionate to the illumination parameter in the particular location to a controller. The controller may provide to the LED a signal to change a parameter of the LED based on a change in the illumination parameter in the particular location.

### CROSS-REFERENCE TO RELATED APPLICATIONS

This application claims priority to U.S. Provisional Application No. 62/737,397 filed Sep. 27, 2018, the contents of which are hereby incorporated by reference herein.

### BACKGROUND

LED array or matrix luminaires are single light fixtures that may be programmed to project different lighting patterns based on selective LED activation and intensity control. Such luminaires can deliver multiple controllable beam patterns from a single lighting device using no moving parts. Typically, this may be done by adjusting the brightness of individual LEDs in a 1 dimensional (1D) or two dimensional (2D) array. Optics, whether shared or individual, may direct the light onto specific target areas.

### SUMMARY

Programmable light emitting diode (LED) lighting systems and a method of operating the system are described. An LED may emit a beam of light at a particular location. The LED may sense, an illumination parameter from an external light source on the particular location. The LED may output a current proportionate to the illumination parameter in the particular location to a controller. The controller may provide to the LED a signal to change a parameter of the LED based on a change in the illumination parameter in the particular location.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 is a diagram illustrating an LED illumination system;

FIG. 2 is a diagram of an LED board with multiple LEDs and an example illuminated control region;

FIG. 3 is a diagram of an LED board with multiple LEDs and separate light sensors associated with respective LEDs;

FIG. 4 is a programming flow chart;

FIG. 5 is a diagram illustrating a LED illumination system flow chart;

FIG. 6 is a flow chart for a method of operating a programmable LED lighting system; and

FIG. 7 is a diagram of an example system that may be used to implement all or some of the embodiments described herein.

### DETAILED DESCRIPTION

Examples of different light illumination systems and/or light emitting diode (“LED”) implementations will be described more fully hereinafter with reference to the accompanying drawings. These examples are not mutually exclusive, and features found in one example may be combined with features found in one or more other examples to achieve additional implementations. Accordingly, it will be understood that the examples shown in the accompanying drawings are provided for illustrative purposes only and they are not intended to limit the disclosure in any way. Like numbers refer to like elements throughout.

It will be understood that, although the terms first, second, third, etc. may be used herein to describe various elements, these elements should not be limited by these terms. These terms may be used to distinguish one element from another. For example, a first element may be termed a second element and a second element may be termed a first element without departing from the scope of the present invention. As used herein, the term “and/or” may include any and all combinations of one or more of the associated listed items.

It will be understood that when an element such as a layer, region, or substrate is referred to as being “on” or extending “onto” another element, it may be directly on or extend directly onto the other element or intervening elements may also be present. In contrast, when an element is referred to as being “directly on” or extending “directly onto” another element, there may be no intervening elements present. It will also be understood that when an element is referred to as being “connected” or “coupled” to another element, it may be directly connected or coupled to the other element and/or connected or coupled to the other element via one or more intervening elements. In contrast, when an element is referred to as being “directly connected” or “directly coupled” to another element, there are no intervening elements present between the element and the other element. It will be understood that these terms are intended to encompass different orientations of the element in addition to any orientation depicted in the figures.

Relative terms such as “below,” “above,” “upper,”, “lower,” “horizontal” or “vertical” may be used herein to describe a relationship of one element, layer, or region to another element, layer, or region as illustrated in the figures. It will be understood that these terms are intended to encompass different orientations of the device in addition to the orientation depicted in the figures.

Further, whether the LEDs, LED arrays, electrical components and/or electronic components are housed on one, two or more electronics boards may also depend on design constraints and/or application.

Selecting which LEDs and associated target areas are to be lit at a defined intensity requires some sort of programming or configuration step. For example, a pattern may be selected on a separate controller, which may be used to configure LED operation. However, this may require extensive experience in lighting and will often involve several iterations of programming and observing the resultant light pattern before achieving a desired result. In addition, needing initial guess work and repeated rounds of observation and reprogramming, an expensive controller system that may only be available during an initial setup phase may be required.

A simple programming system that easily supports a plurality of LEDs, such as in LED array based luminaires or other lighting systems, may be desirable. Such a programming system may allow for non-experts to program lighting patterns and may be easy to reprogram if changes in lighting patterns are desired.

In addition to its common usage for emitting light, an LED may be used as a photodiode light sensor. This capability may be used for ambient light level detection, one way light communication, or bidirectional communications. As a photodiode, an LED may be generally sensitive to wavelengths equal to or shorter than the predominant wavelength it emits. When exposed to light, photodiodes may produce a current that is directly proportional to the intensity of the light. This light generated current flows in an opposite direction to current in a normal diode or LED. As more photons hit the photodiode, the current may increase, which may cause a voltage across the diode. In operation, this may allow for an LED emitter/sensor to respond to an externally projected beam using the same optic that projects a beam of light from an LED emitter, focusing light to trigger the LED sensor. Forward beam shaping for the LED emitter for any combination of optics may also provide backward beam shaping for the LED sensor operation.

In embodiments, such a dual function light emitting and sensing LED may be a single LED that is segmented into a light-emitting and a light-sensing region with appropriate circuitry to enable the light-emitting section to emit light while the light-sensing region senses light. In other embodiments, a non-segmented dual function LED may be implemented in conjunction with a controller and appropriate circuitry to cycle the LED through light emitting and light sensing phases. In other embodiments, a non-segmented dual function LED may be implemented in conjunction with a controller and appropriate circuitry to both emit and sense light at the same time. One of ordinary skill in the art will understand that these are just examples of different types of dual function LEDs and that any dual function LED may be used consistent with the embodiments described herein. Further, in other embodiments described in more detail below, separate LED emitters and sensors may be included in an LED lighting system.

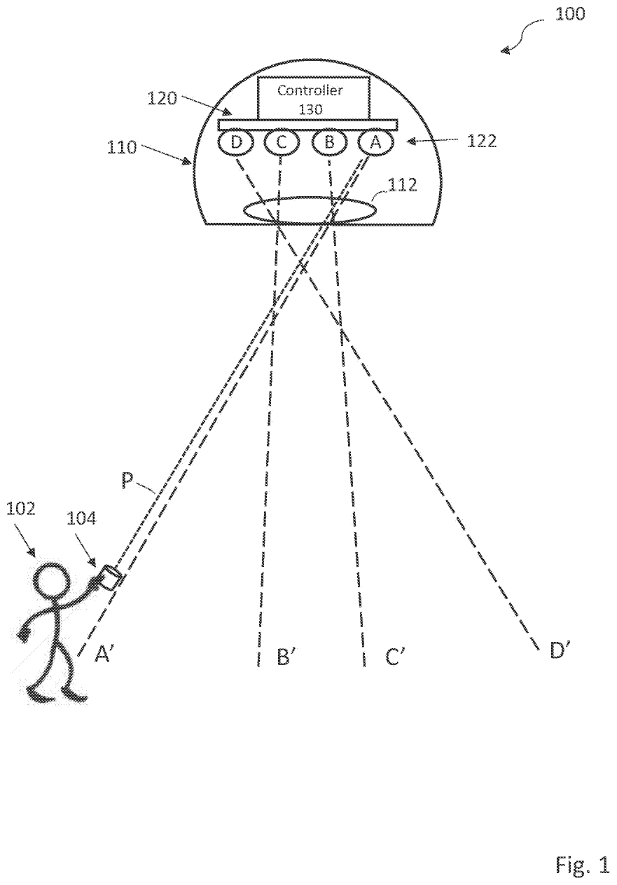

FIG. 1 is a diagram of a programmable LED lighting system 100 that may utilize light sensor properties of an LED. A luminaire 100 may include an optic 112 and an LED board 120 supporting a plurality of LED elements 122 (designated as A, B, C, and D in the Figure). Light emitted from LED elements A, B, C, and D respectively follow paths indicated as A′, B′, C′, and D′.

A controller 130 may connect to the LED elements 122 to permit on/off and/or luminous intensity adjusted operation. A user 102 may program the lighting system 100 using a directable light source 104, such as a flashlight, laser, or other suitable light beam emitting device. When the system 100 is in a programming mode, emitted light (beam P) from directable light source 104 is sensed by one or more of the LED elements A, B, C, or D. In this example, light is directed toward LED element A. This information may be used to increase light intensity, decrease light intensity, or otherwise modify operation of LED elements 122. In an embodiment, the light may be directed towards a surface of where light paths A′ or B′ or C′ or D′ illuminate. In an embodiment, luminous intensity may be adjusted continuously or in stepped increments.

The LED board 120 may include circuitry to enable the operation of the plurality of LED elements 122. Furthermore, the LED board 120 may include circuitry to enable individual or grouped operation of the plurality LED elements 122. In an embodiment, each LED may be separately controlled by controller 130. In an embodiment, groups of LEDs may be controlled as a block. In an embodiment, both single LEDs and groups of LEDs may be controlled. In an embodiment, intensity may be separately controlled and adjusted by setting appropriate ramp times and pulse width for each LED using a pulse width modulation module within controller 130. This may allow staging of LED activation to reduce power fluctuations and to provide superior luminous intensity control.

The LED elements 122 may include but are not limited to LEDs formed of sapphire or silicon carbide. The LED elements 122 may be formed from an epitaxially grown or deposited semiconductor n-layer. A semiconductor p-layer may then be sequentially grown or deposited on the n-layer, forming an active region at the junction between layers. Semiconductor materials capable of forming high-brightness light emitting devices may include, but are not limited to, Group III-V semiconductors, particularly binary, ternary, and quaternary alloys of gallium, aluminum, indium, and nitrogen, also referred to as III-nitride materials. In an embodiment, laser light emitting elements may be used.

Color of emitted light from the LED elements 122 may be modified using a wavelength converting element, such as phosphor contained in glass or some other material, or as a pre-formed wavelength converting element, such as a sintered ceramic phosphor, which may include one or more wavelength converting materials able to create white light or monochromatic light of other colors. All or only a portion of the light emitted by the LED elements 122 may be converted by the wavelength converting material of the wavelength converting material. Unconverted light may be part of the final spectrum of light, though it need not be. Examples of common devices include a blue-emitting LED segment combined with a yellow-emitting phosphor, a blue-emitting LED segment combined with green- and red-emitting phosphors, a UV-emitting LED segment combined with blue- and yellow-emitting phosphors, and a UV-emitting LED segment combined with blue-, green-, and red-emitting phosphors. In embodiments where a dual function LED is used for both emitting and sensing, additional processing may be performed on sensing information provided by the LED to compensate for the presence of the wavelength converting material.

Direction of light emitted from each LED element 122 may be modified by optic 112. Optic 112 may be a single optical element or multiple optical elements. Optical elements may include converging or diverging lenses, aspherical lens, Fresnel lens, or graded index lens, for example. Other optical elements, such as mirrors, beam diffusers, filters, masks, apertures, collimators, or light waveguides may also be included. Optic 112 may be positioned at a distance from the LED elements in order to receive and redirect light from multiple LED elements 122. Alternatively, optic 112 may include multiple optical elements, each of which may be set adjacent to each LED element to guide, focus, or defocus emitted light. In an embodiment, optic 112 may be connected to actuators for movement. In an embodiment, actuator movement may be programmed. This may allow, for example, a lens to be moved to increase or decrease beam size.

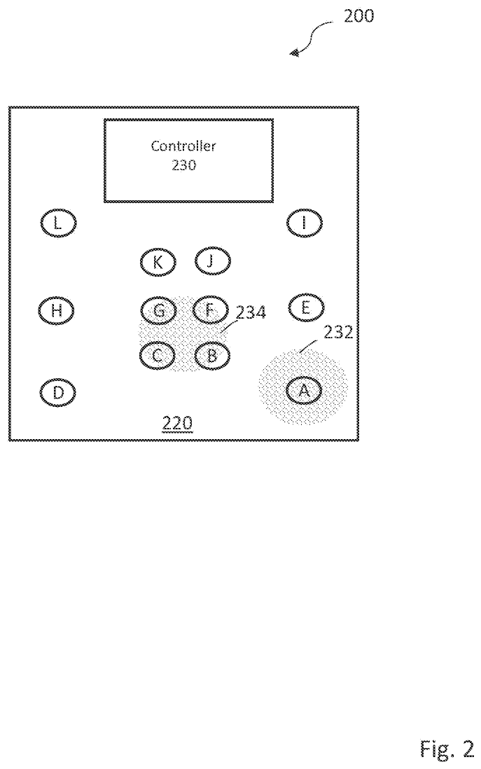

FIG. 2 illustrates an example board layout 200 for a printed circuit board 220 supporting multiple LED elements (indicated as A-L in the Figure) and a controller 230 configured to provide a lighting pattern such as described with respect to FIG. 1. To reduce overall data management requirements, the controller 230 may be limited to on/off functionality or switching between relatively few light intensity levels in response to a directed light beam 232 or 234, but, in some embodiments, may have additional functionality. Both individual (e.g., A, D, E, H, I, and L) and group level (e.g., B, C, F, G) control of light intensity is shown. In this embodiment, overlapping or dynamically selected zones of control are also possible, with, for example, overlapping groups (e.g., B, C, F, G) and (e.g., F, G, J, K) being separately controllable despite having common LED elements (e.g., F, G) depending on exact beam position.

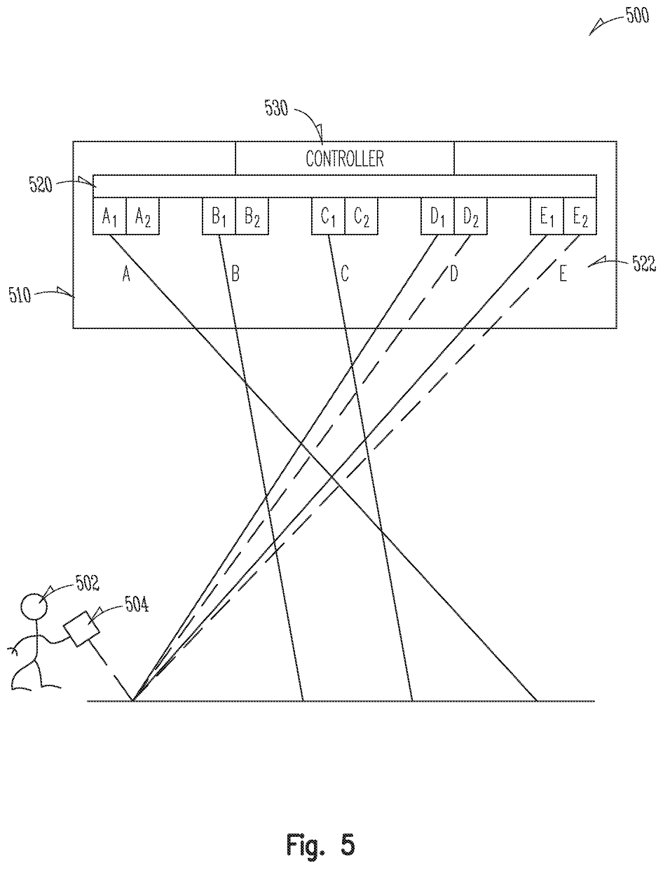

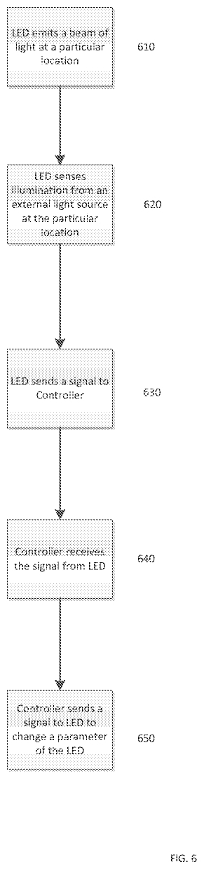

In the example illustrated in FIG. 2, the LED elements A-L may be split emitting and sensing LED devices. For example, the LED devices may have an emitting region and a sensing region, as described in more detail below with respect to FIGS. 5 and 6, or may be a non-segmented LED that emits and senses light either at different times or the same time.

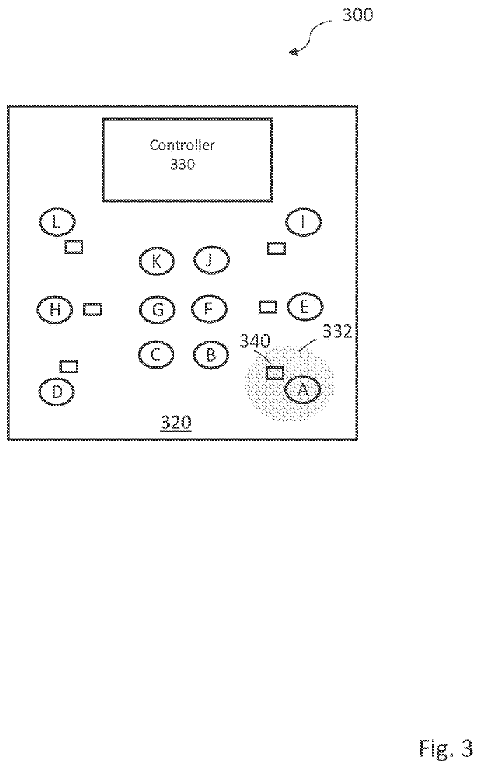

FIG. 3 illustrates an example board layout 300 for a printed circuit board 320 supporting multiple LED elements (indicated as A-L in the Figure) and a controller 330 configured to provide a lighting pattern such as described with respect to FIG. 1. Unlike the embodiment illustrated in FIG. 2, in this embodiment, separate light sensors 340 respond to directed light beams (e.g., beam 332) and may be positioned adjacent to respective LED elements and used to relay signals to the controller 330 for programming light intensity or other properties of associated LED elements. In an embodiment, such light sensors may be responsive to infrared light, allowing traditional infrared data transfer protocols to provide additional bidirectional information. In this embodiment, the centrally located LED elements (e.g., B, C, F, G, J, K) may be controlled as a group using one or more LED elements as light sensors, while other LED elements (e.g., A, D, E, H, I, and L) may be separately controlled.

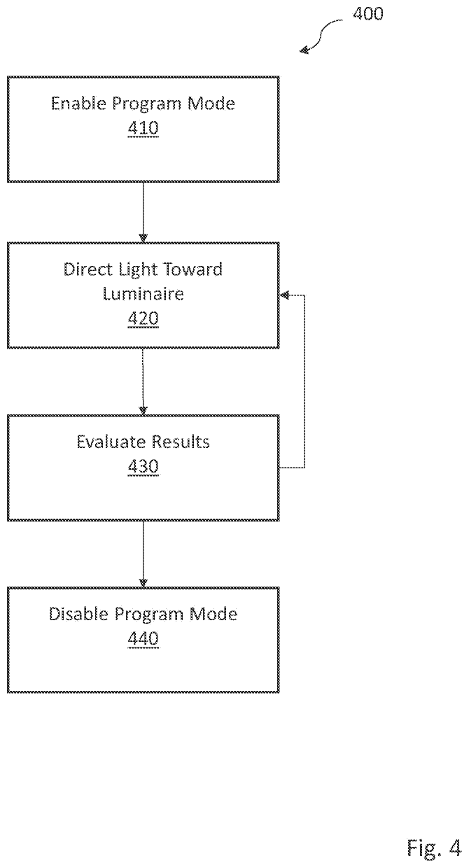

FIG. 4 illustrates a method of operation 400 of a programmable light emitting diode (LED) lighting system with one or more arrays of LEDs. A program mode 410 may be enabled. Use of a specific light flash pattern, activation of a mechanical or electronic button, or a wireless mediated network request may be used. A user may then direct a light beam toward the luminaire (420). Alternatively or in addition, the light beam may be directed to a surface that is illuminated by the luminaire. The light beam may be provided by a flashlight, laser pointer, or smartphone LED flash. Depending on the coding, the directed light beam may increase, decrease, or adjust a light intensity of the LED(s). Coding may include light on/off, intensity coding, time based coding (e.g. single, or multiple light flashes of various durations), or digital coding using Li-Fi or other suitable light based protocols. Unidirectional (from user to luminaire) or bidirectional information transfer can be supported. For those embodiments with actuators for movable optics, the beam width may be adjusted. The results may be evaluated, and further adjustments may be made to that LED or additional LEDs (430). When programming is finished, the program mode may be disabled (440).

Programmable light emitting arrays may support a wide range of applications that benefit from fine-grained intensity, spatial, and temporal control of light distribution. This may include, but is not limited to, precise spatial patterning of emitted light from blocks or individual LEDs. Depending on the application, emitted light may be spectrally distinct, adaptive over time, and/or environmentally responsive. In some embodiments, the light emitting arrays may provide pre-programmed light distribution in various intensity, spatial, or temporal patterns. The emitted light may be based at least in part on received sensor data and may be used for optical wireless communications. Associated optics may be distinct at single or multiple LED level. An example light emitting array may include a device having a commonly controlled central block of high intensity LEDs with an associated common optic, whereas edge positioned LEDs may have individual optics. Common applications supported by light emitting LED arrays include video lighting, automotive headlights, architectural and area illumination, street lighting, and informational displays.

Programmable light emitting arrays may be used to selectively and adaptively illuminate buildings or areas for improved visual display or to reduce lighting costs. In addition, light emitting arrays may be used to project media facades for decorative motion or video effects. In conjunction with tracking sensors and/or cameras, selective illumination of areas around pedestrians may be possible. Spectrally distinct LEDs may be used to adjust the color temperature of lighting, as well as support wavelength specific horticultural illumination.

Street lighting is an important application that may greatly benefit from use of programmable light emitting arrays. A single type of light emitting array may be used to mimic various street light types, allowing, for example, switching between a Type I linear street light and a Type IV semicircular street light by appropriate activation or deactivation of selected LEDs. In addition, street lighting costs may be lowered by adjusting light beam intensity or distribution according to environmental conditions or time of use. For example, light intensity and area of distribution may be reduced when pedestrians are not present. If LEDs of the light emitting array are spectrally distinct, the color temperature of the light may be adjusted according to respective daylight, twilight, or night conditions.

Programmable light emitting LEDs are also well suited for supporting applications requiring direct or projected displays. For example, automotive headlights requiring calibration, or warning, emergency, or informational signs may all be displayed or projected using light emitting arrays. This allows, for example, modifying directionality of light output from an automotive headlight. If a light emitting array is composed of a large number of LEDs or includes a suitable dynamic light mask, textual or numerical information may be presented with user guided placement. Directional arrows or similar indicators may also be provided.

FIG. 5 illustrates a programmable light emitting diode (LED) lighting system 500. A luminaire 500 may include an LED board 520 supporting a plurality of LED elements 522 (designated as A, B, C, D, and E). Each LED may have an emitter region (A₁, B₁, C₁, D₁, and E₁). An emitter region of an LED may be configured to emit a beam of light at a particular location. Each LED may have a sensing region (A₂, B₂, C₂, D₂, and E₂). A light sensing region of an LED may be configured to sense an illumination parameter from an external light source (504). An illumination parameter may include, for example, color, brightness, intensity, amount, geographical size, a pattern of illumination, such as a flashing pattern, coded information and intensity of a coded signal.

The external light source may be operated by a user (502). The external light source may be any device that may emit a light beam, either visible or invisible, such as infrared. For example the light source may be a mobile phone, flashlight, or laser pointer.

The LEDs may be configured to output a current. The current may be proportionate to a sensed illumination parameter. The controller may be configured to receive the current output from an LED and provide a signal to the LED to change a parameter of the LED based on a change in the illumination parameter. The parameter of the LED may include, for example, a power state, intensity, brightness, and color. In embodiments, light arriving at the LED may be sensed as a change in current through the LED, as indicated above, or as a voltage.

FIG. 6 is a flowchart that illustrates a method of operating a programmable LED lighting system 500. An LED may emit a beam of light at a particular location (610). A user may direct illumination at the particular location using an illumination device. The LED may sense the illumination, which may have a particular parameter, in the particular location (620). The LED may send a signal to the controller (630). The signal may be a current, which may be proportionate to the illumination parameter that was sensed, or a voltage. The controller may receive the signal from the LED (640). The controller may provide a signal to the LED to change a parameter of the LED (650). The change may be based on a change in the illumination parameter in the particular location. The LED may emit a beam of light based on the signal to change a parameter. The change may be based on a time parameter. The change may be based on an occupancy sensor.

As mentioned above, an LED lighting system may be implemented using either separate LED emitters and sensors, as a segmented LED with light-emitting and light sensing regions, or as a single LED that is controlled to act as both an emitter and sensor at either the same or different times. Accordingly, in embodiments, in 610, the LED may emit a beam of light at a particular during first time periods and, in 620, may sense illumination in the location, during second time periods. Accordingly, the light sensed in the location may be a combination of both the light emitted from the LED and the light emitted from an additional device (such as operated by the user) and, thus, may be sensed as a change in illumination in the location. This may also be true for embodiments where a non-segmented LED emits and senses light at the same time. In embodiments where an LED cycles between emitting and sensing functionality or otherwise emits and senses light at different times, the light in the location may be sensed as a presence of light when no light is expected or as a change in sensed light. Where separate LED emitters and sensors are used, light may be sensed in any of the ways described above or may be sensed as a different type of light, such as invisible light, which may or may not provide additional information to the sensor.

The programmable LED lighting system may be commanded into a programming mode. For example, a mobile phone may be able to initiate a programming mode of the programmable LED lighting system. The mobile phone may have an application to facilitate the programming mode. The programming mode may be enabled for example by flashing a coded signal in a field of view of the luminaire. The luminaire may confirm enablement of a programming mode. A confirmation may include, for example, a flashing light beam, dimming of a light beam, or turning off a light beam.

A user may point an external light source, such as a mobile phone flashlight, at a region where the user wants to effect a change of illumination For example, the user may point a mobile phone flashlight at a location on a table, floor, or wall. The LED may sense the illumination and then illuminate that location.

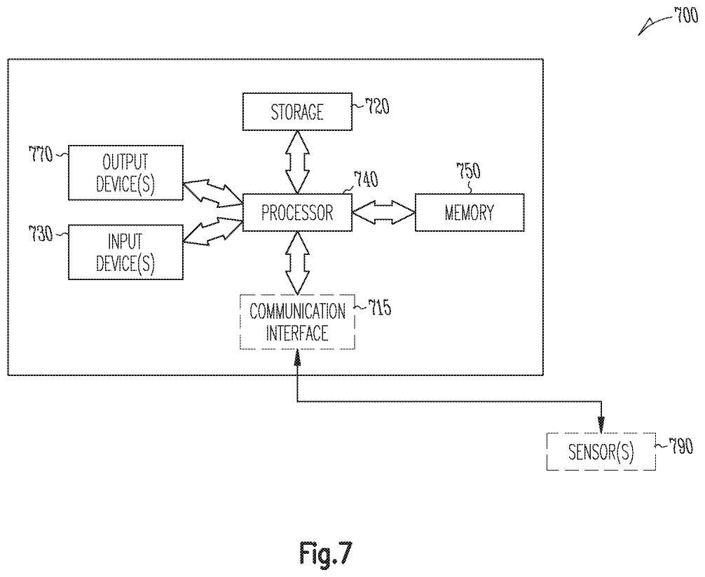

FIG. 7 is a diagram of an example system 700 that may be used to implement all, some or portions of the embodiments described herein. In the example illustrated in FIG. 7, the system 700 may include a processor 740, a memory 750, storage 720, one or more input devices 730, one or more output devices 770, and an optional communication interface 715. The optional communication interface 715 may be communicatively coupled to one or more sensors 790 in some embodiments. One of ordinary skill in the art will understand that system 700 may include additional components not shown in FIG. 7.

The processor 740 may include a central processing unit (CPU), a graphics processing unit (GPU), a CPU and GPU, and/or one or more processor cores. The memory 750 may include a volatile or non-volatile memory, for example, random access memory (RAM), dynamic RAM, or a cache. The storage 720 may include a fixed or removable storage, for example, a hard disk drive, a solid state drive, an optical disk, or a flash drive. The one or more input devices 730 may include, for example, a keyboard, a keypad, a touch screen, a touch pad, a detector, a microphone, an accelerometer, a gyroscope, a biometric scanner, and/or a network connection (e.g., a wireless local area network card for transmission and/or reception of wireless IEEE 802 signals). The one or more output devices 770 may include, for example, a display, a speaker, one or more lights, an antenna, and/or a network connection.

The communication interface 715 may be any device capable of receiving inputs from, and providing outputs to, peripheral devices. In embodiments, the communication interface may one or a combination of a modem, wireless router, USB connector, blue tooth, or any type of circuitry used to exchange information between the processor and the sensors in either one or both directions. In embodiments, the communication interface 715 may be omitted and/or may be or include circuitry that may enable read out of a level of the sensors and/or control of light emission of the LEDs.

The one or more sensors 790 may be any type of sensor and, in particular, may be sensors or LEDs used to sense and/or emit light. In such embodiments, the system 700 may control the sensors to measure the light, as described above, and/or emit light, such as to cycle or otherwise change the LEDs between operation as sensors or emitters.

While the system 700 is shown as a single unit, one of ordinary skill in the art will recognize that the system 700 can have portions that are split between different locations. For example, the entire system 700 could be located on the board with the LEDs and/or sensors and/or all or portions of the system may be located on the board while other elements may be located off board. Additionally, only some elements of the system 700 may be used in an implementation. For example, a storage device and/or memory may not be needed.

Having described the embodiments in detail, those skilled in the art will appreciate that, given the present description, modifications may be made to the embodiments described herein without departing from the spirit of the inventive concept. Therefore, it is not intended that the scope of the invention be limited to the specific embodiments illustrated and described.

What is claimed:

1. A programmable light emitting diode (LED) lighting system comprising:
a plurality of LEDs, at least one of the plurality of LEDs having a light e-mitting region and a light sensing region and positioned such that the light-emitting region emits a beam of light at a particular location and the light sensing region senses an illumination parameter from an external light source on the particular location, the light sensing region being electrically coupled to output a current proportionate to the illumination parameter in the particular location; and
a controller communicatively coupled to the at least one of the plurality of LEDs and configured to receive the current output from the light sensing region and provide a signal to the at least one LED to change a parameter of the least one LED based on a change in the illumination parameter in the particular location.

2. The programmable LED lighting system of claim 1, wherein the parameter of the at least one LED is a power state.

3. The programmable LED lighting system of claim 1, wherein the parameter of the at least one LED is light intensity.

4. The programmable LED lighting system of claim 1, wherein the illumination parameter is an amount of illumination.

5. The programmable LED lighting system of claim 1, wherein the illumination parameter is brightness.

6. The programmable LED lighting system of claim 1, wherein the illumination parameter is a pattern of illumination.

7. The programmable LED lighting system of claim 1, wherein the illumination parameter is geographical size.

8. The programmable LED lighting system of claim 1, wherein the light sensing region senses infrared light.

9. A method of operating a programmable light emitting diode (LED) lighting system comprising a plurality of LEDs, the method comprising:
emitting, by at least one of the plurality of LEDs, a beam of light at a particular location;
sensing, by the at least one LED, an illumination parameter from an external light source on the particular location;
outputting, by the at least one LED, an indication of the illumination parameter in the particular location;
providing, by a controller to the at least one LED, a signal to change a parameter of the at least one LED based on the indication provided by the at least one LED.

10. The method of claim 9, wherein the indication is at least one of a current and a voltage proportionate to the illumination parameter at the particular location.

11. The method of claim 9, further comprising:
emitting, by the at least one LED, an updated beam of light based on the signal from the controller.

12. The method of claim 9, wherein the parameter of the at least one LED is a power state.

13. The method of claim 9, wherein the parameter of the at least one LED is light intensity.

14. The method of claim 9, wherein the illumination parameter is an amount of illumination.

15. The method of claim 9, wherein the illumination parameter is brightness.

16. The method of claim 10, wherein the illumination parameter is a pattern of illumination.

17. The method of claim 9, wherein the illumination parameter is geographical size.

18. The method of claim 9, wherein the at least one LED senses infrared light.

19. The method of claim 9, wherein the emitted beam of light is distinguishable from the sensed illumination.

20. A programmable light emitting diode (LED) lighting system comprising:
a plurality of LEDs arranged to emit beams of light directed toward particular locations; and
a controller, communicatively coupled to the at least one of the plurality of LEDs, and configured to:
control the at least one of the plurality of LEDs to operate in a light emitting mode and a light sensing mode,
during the light sensing mode, receive an indication from the one of the plurality of LEDs of a change in illumination in a corresponding one of the particular locations from an external light source, and
in response to receiving the indication, change a parameter of the least one LED.
